(19) United States
(12) Patent Application Publication
(10) Pub. No.: US 2008/0033827 A1
(43) Pub. Date: Feb. 7, 2008

(54) Nutrition / diet control system

(76) Inventors: Shaobo Kuang, Lansdale, PA (US); Yinan Kuang, Lansdale, PA (US)

Correspondence Address: Shaobo Kuang, 1243 Meadowview Cir, Lansdale, PA, 19446, US

(21) Appl. No.: 11/497,480

(22) Filed: Aug. 2, 2006

(51) Int. Cl. G06Q 30/00; G06F 17/30

(52) U.S. Cl. 705/15; 707/1

(57) ABSTRACT

The present invention relates to a system for diet control; more specifically, to an autonomous portable electronic device, which allows the user easily, input a nutrition facts data about the food he or she takes into the device. The device can extract, display, and store in a cumulative fashion the nutrition facts he or she takes, and possibly give a warning message when the user takes more nutrition facts than their needs, and possibly give a suggestion helping the user to select to meal. Also, the device can easily send the user's nutrition information to the restaurant/food store when they buy the food so the restaurant/food store can make the food based on the user's nutrition requirement. Also, the device can count the energy consumed by the user, and give the user a hint on how to adjust his or her nutrition/diet control.

The present invention is based on the provisional Patent Application, Ser. No. 10/716,558, filed on Sep. 14, 2005, titled “Nutrition/diet control system”.

### FIELD OF THE INVENTION

The present invention relates to a device/system for nutrition or diet control, more specifically, a restaurant or food/grocery store host system, and to an autonomous portable electronic device which easily allows the user to input nutrition facts data and other information about the food he or she takes for their diet watch or nutrition control.

### BACKGROUND OF THE INVENTION

A large percentage of the United States adult population is overweight. Many publications are available regarding diet/nutrition control or weight watching, which their readers hope will provide an easy solution to their weight problems. Competent medical specialists who have studied the problems of obesity generally are convinced, however, that the only effective method of controlling weight is to balance the intake of energy in the form of food with the expenditure of energy in the form of activity. Whenever an imbalance exists in the form of a greater energy intake than is expended, an increase in weight results. In theory, the maintenance of a balanced caloric intake/expenditure should be easily established. Readily available charts have been published which provide accurate data on the caloric content of all types of foods and beverages. In addition, caloric expenditures of a wide range of human activities from sleep through strenuous exercise have been measured and charted. Many thousands of individuals have succeeded in achieving their desired weight and maintaining that weight by balancing their caloric intake with expenditure. Therefore, many persons use so-called calorie counters or pedometers for watching their weight. For example, walking burns calories. To figure out how you are doing, here is a simple equation: If you walk at the leisurely pace of 3 miles per hour, you can burn about 300 calories in an hour.

Controlling one's nutrition intake is a major focus of health maintenance. Moderation of caloric and fat intake is a common concern for the public. Precise control of elements such as sodium, protein, and fiber are required for segments of the population whose health has been compromised by medically important conditions.

The FDA was worried that Americans had no way to judge food labels to make healthy food selections. After many months of hearings and debate, it came up with a solution—give all Americans a Nutrition Budget, a Daily Value for fat, saturated fat, cholesterol, sodium, total carbohydrate, and dietary fiber. Consumers would like to be abnormally diligent to add up the % Daily Value for each serving of each food that they eat to make sure they eat less than 100 percent of the Daily Value for each nutrient each day.

The Daily Value gives us an easy way to watch our nutrition intake. Therefore, there are many designs or proposals that seek to allow the user to input the % Daily Value into to a computer or an electronic device, which will show the user how much the nutrition facts they have taken in the serving. The patent application (U.S. Pat. No. 5,819,735) even suggests using a bar code scanner to help the users to enter the nutrition facts into a device or a computer. U.S. Pat. No. 4,686,624 to Blum uses a database that contains food names, such as semi-skimmed milk, and the related nutrition facts. Sakai, in U.S. Pat. No. 4,855,945 describes a similar device, wherein a nutrition fact database can be accessed by entering actual food names via an alphanumeric keypad. It is not easy for the user to enter the food nutrition data into their portable device, such as a cell phone or PDA, while they are ordering their food.

Using a scanner to scan the nutrition facts information into the device will add the cost into the device, and also requires the food providers to put the bar code labels on the food box or on the restaurants' menu. Another disadvantage of the prior art is that it cannot show you the relation or the link between the nutrition/energy (calories) you took and the nutrition/energy (calories) you consumed.

Research shows that people who keep track of what they eat have better weight-loss success. People tracking what they eat will pay more attention about what they eat, will get a better diet result. In hospitals or diet clubs, there are nurses or trainers helping patients or the club members tracking their take nutrition/energy data. The nutrition facts label is now the best and most widely used source for nutrition information. Now, when you buy a package of food from supermarket or a food/grocery store, you can easily find the nutrition information about the food on the nutrition facts label on the package. However, when you eat a meal in a restaurant, such as Burger King or McDonald's, it is not easy for you to find the nutrition information about the food you ordered. Some restaurants, like McDonald's, give their customers a well-printed paper listing the nutrition information for all their meals on their menu. Since there is a great deal of nutrition information on this paper, few customers will take the time to look at the paper and count out how many fats or calories he or she is taking, especially when an extra side comes with the meal they ordered. Also, some people will be allergic to a certain ingredients in the food, such as eggs. Usually, many new employees in a restaurant or a food store don't have much knowledge about the ingredients in the foods they provide. In some cases, such as in a hospital or a diet club, or even a health insurance company, the doctors or the diet instructors want to keep track of the nutrition, such as fats and calories, that their patients or clients have taken, and the nutrition/calories they have consumed. However, the prior art technology didn't provide a good solution or answer to these issues.

### SUMMARY OF THE INVENTION

It is therefore the objects of the present invention are intended to overcome the drawbacks of the conventional art.

Accordingly, an object of the present invention is to provide a method and a system which allows the food/meal provider, such as a restaurant, food/grocery store to easily tell/show their customers the nutrition facts or diet information about the food/meal they ordered.

Another object of the present invention is to provide a method and a system which quickly and easily allows the user to tell/inform the food/meal provider his nutrition/diet requirements.

Another object of the present invention is to provide a method and a system which quickly and easily allows the user to tell the food/meal provider his or her ingredient requirements, such as if he or she cannot eat eggs.

Another object of this invention is to provide a simple solution to allow the user to input the nutrition facts into a device.

Another object of the present invention is to provide a simple nutrition facts label solution to allow both the food providers and the users to apply easily.

Another object of the present invention is to provide a method and a device to allow the user to enter an encrypted or shortened code for the nutrition data for the meal he or she has eaten. The method and the device are able to convert the encrypted or shortened code back to the regular nutrition fact data.

Another object of the present invention is to provide a method and a device, which is able to establish the relationship or the link between the nutrition the user consumes and the calories the user burns.

Another object of the present invention is to provide a diet-monitoring device that is portable, and of a size and construction that will allow it to be conveniently placed anywhere, such as in the pocket.

Another object of the present invention is to provide a diet-monitoring device that is portable, and of a size and construction that will allow it to be conveniently placed anywhere, such as in the pocket. The device is preferred the device like cell phone, blackberry, and other mobile device that, now, many users took it every day already.

Another object of the present invention is to provide a diet-monitoring device that is able to track how much energy (calories) the user has consumed.

Another object of the present invention is to provide a method and a device that is able to give the user a warning or a suggestion about the nutrition facts based on the daily value nutrition he or she has taken, the energy (calories) he or she has consumed, and the energy (calories) he or she needed.

Another object of the present invention is to provide a method and a device to track personalized nutritional goals for individual users using nutrition data. In many cases, the user will decide to consume more or less than a predetermined serving size of a product based on the nutrition/energy (calories) he or she has taken, the nutrition/energy (calories) he or she has consumed, and the nutrition/energy (calories) he or she needed.

Another object of the present invention is to provide a method and a device to allow the design of a personal diet strategy based on limiting the consumption of one or more nutrient types, such as calories or fat, and the energy (calories) consumed already, so that the user can choose which aspects of diet he or she would like to control.

Another object of the present invention is to provide a method and a device to suggest the user to take more exercise based on the user's nutritional goal, the nutrition/energy he or she has taken, the nutrition/energy he or she has burned, and the nutrition/energy he or she needed.

Another object of the present invention is to provide a method and device to automatically pass the information about the nutrition, such as fats, calories the users taken and the nutrition/calories the users consumed, to those who are concerned, such as doctors, health insurance companies, or diet instructors.

Further objects and advantages of our invention will become apparent from a consideration of the drawings and ensuring descriptions.

A nutrition control system according to the present invention includes an order taking or cashier machine which further includes:
means for processing data, such as calculations;
means for storing the data, such as meal/price table;
means for entering the order, such the food name, or the order number of the meal shown on the menu;
means for printing the order ticket or the receipt;

wherein the said nutrition control system further includes a storage means for storing the information regarding the nutrition or energy/food or meal; the said processing means can lookup the nutrition information by a given food or meal from the said storage means, and have the printing means to print the nutrition/energy information on the order ticket or the receipt for the meal ordered.

A nutrition control card according to the present invention includes one or more machine-readable code, such as barcode or RFID, for representing the user preferred nutrition information; the said order taking system or cashier machine read the said code and get the selection range from the said nutrition information storage based on the user preferred nutrition information.

A nutrition or diet control device according to the present invention includes:
means for processing data,
means for storing data,
means for displaying the information to the user,
means for inputting or entering data,
means for counting the step the user walked,

wherein, the said nutrition or diet control device further include the storing means for storing the information or data for the nutrition/energy the user needed, the nutrition/energy the user has taken, and the nutrition/energy the user has consumed, the user enter the nutrition/energy taken, or even the nutrition/energy consumed into the device through said inputting or entering means, the step counting means count the step the user has taken, and send the count to processing means, the processing means convert the step counts into nutrition/energy consumed data and store the nutrition/energy consumed data automatically into said nutrition information/data storing means, the processing means checks the nutrition/energy the user needed, the nutrition/energy the user has taken, and the nutrition/energy the user has consumed, and have the display means to display the said nutrition/energy information to the users, or have the displaying means to display a warning message if the nutrition/energy taken—the nutrition/energy consumed>the necessary nutrition/energy or the predefined nutrition/energy goal.

A method of selecting at least a food name from a plurality of food names in a small portable device configured to present sequentially a food category, food sub-category, and food name display screen or pull-down menu on the display of the device, the plurality of food names accessed according to hierarchy, the hierarch having a plurality of food categories, food subcategories, and the food names respectively in a food category, food sub-category, and food name level of the hierarchy, the method comprising:

selecting a food category in the food category display screen or pull-down menu;

displaying the food subcategories belonging to the selected food; category in a listing presented in the subcategory display screen or pull-down menu;

selecting a food subcategory in the food subcategory display screen or pull-down menu;

displaying the food names belonging to the selected subcategory in a listing presented in the food names display screen or pull-down menu

accessing one food names on the food name display screen or the pull-down menu.

According to the present invention, the said food name selecting method, further comprises displaying/showing a sign to the users indicating the foods/meals on the list with the nutrition facts or ingredients meeting the users nutrition requirements or not meeting the users requirements.

According to the present invention, the said food name selecting method, the step of displaying the food names belonging to the selected subcategory is to only display the names of the foods/meals with the nutrition facts or ingredients meeting the users nutrition/ingredient requirements.

A cell phone or the like with nutrition or diet control function according to the present invention includes:
means for receiving signals,
means for sending signals,
means for processing data,
means for storing data,
means for displaying the information to the user,
means for inputting or entering data, and the said cell phone further includes
means for counting the steps the user walked,
means for storing the information or data for the nutrition/energy the user needed, the nutrition/energy the user has taken, and the nutrition/energy the user has consumed,

wherein the user enter the nutrition/energy taken, or even the nutrition/energy consumed into the nutrition information storing means through said inputting or entering means, the step counting means count the step the user has taken, and send the count to processing means, the processing means convert the step counts into nutrition/energy consumed data and store the nutrition/energy consumed data automatically into the nutrition information storing means, the processing means will, timely, such as daily, check the nutrition/energy the user needed, the nutrition/energy the user has taken, and the nutrition/energy the user has consumed, and have the displaying means to display a warning message if the nutrition/energy taken—the nutrition/energy consumed>the necessary nutrition/energy or the predefined nutrition/energy goal.

A cell phone or the like with nutrition or diet control function, according to the present invention, further includes

storage means for storing the food names and their corresponding nutrition/energy information,

wherein when user select a particular food from the said displaying means, the said processing means will look for the nutrition/energy information, and shows the found nutrition/energy information on the displaying means to the user.

The present invention is described in the detail below, together with its further objectives, features, and advantages, in conjunction with the following drawings:

### BRIEF DESCRIPTION OF THE DRAWINGS

FIG. 1 is a schematic drawing showing an example nutrition control system in accordance with the present invention.

FIG. 2A shows a restaurant/food store order ticket or receipt in a restaurant.

FIG. 2B shows a restaurant/food store order ticket or receipt in accordance with the present invention.

FIG. 3A is a schematic drawing showing an example of a portable nutrition control/weight watch device in accordance with the present invention.

FIG. 4 shows an example of the nutrition card in accordance with the present invention.

FIG. 5 is a schematic drawing showing a portable nutrition control device in accordance with the present invention.

FIG. 6 is a schematic drawing showing a cell phone with a step counter/pedometer in accordance with the present invention.

FIG. 7 is a flow chart showing an example of how the device in FIG. 6 works.

FIG. 8 is a flow chart showing another example of how the device in FIG. 6 works.

FIG. 9 is a schematic diagram of a hierarch tree structure for inputting the nutrition/energy into the nutrition control system in accordance with the present invention.

### DETAILED DESCRIPTION OF THE INVENTION

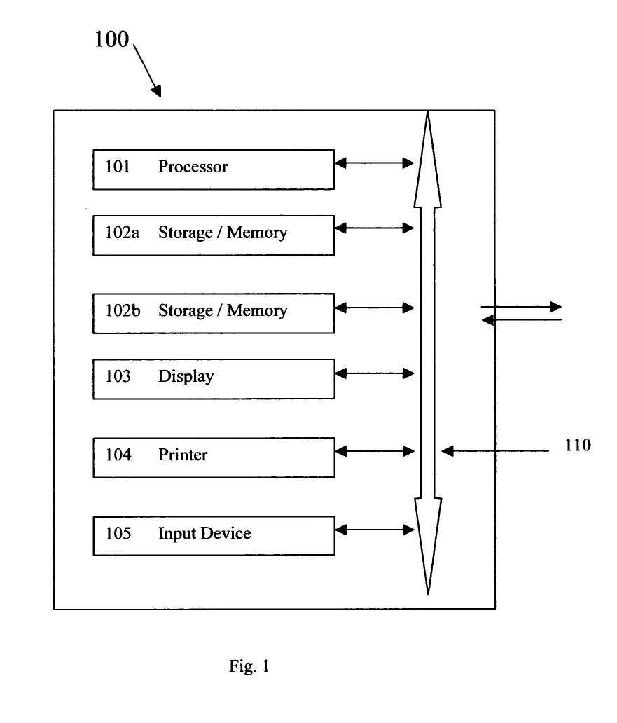

Referring now to the drawings, FIG. 1 shows an ordering or cashier system with nutrition control in accordance with the present invention. In this example, 100 is an ordering or cashier machine in a restaurant/food store/grocery store, which includes 101 processor, 102 storage/memory, 103 display device, 104 printing device, 105 key board or the other type input device, and 110 data bus. Storage/Memory 102a is used for storing the information about the food and its price, which is common to the regular casher machine. Storage/Memory 102b is for storing the information about the food and its nutrition facts data. When a customer makes an order, for example, he wants a Hamburger, a Coke and Fries, after the cashier/the clerk inputs the customer's order into the cashier machine 100 through the input device 105, the processor 101 will look up the price for each items in the order from the storage/memory 102a, and sum up the total price for this order. The processor 101 will also look up the nutrition facts data for each items or sub-items in the order from the storage/memory 102b, and sum up the total nutrition facts for each individual order/meal in the order. The system will print the customer's order ticket or the order receipt in a small slip/piece of paper, which shows the customer order with the food item name, the price, and also the nutrition information for each individual order/meal. The system may also display the nutrition data for the customer order on the display device 103 when processing the order.

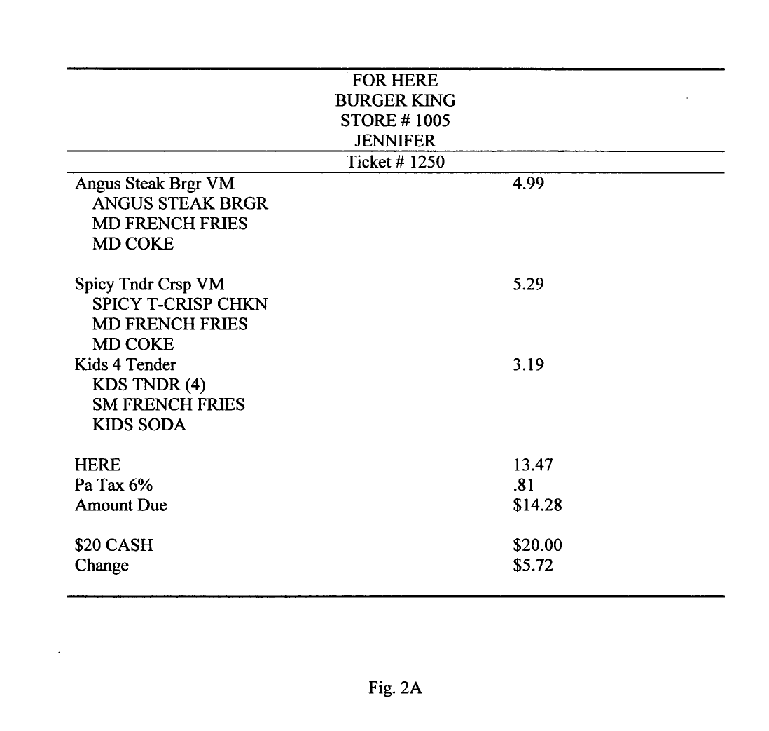

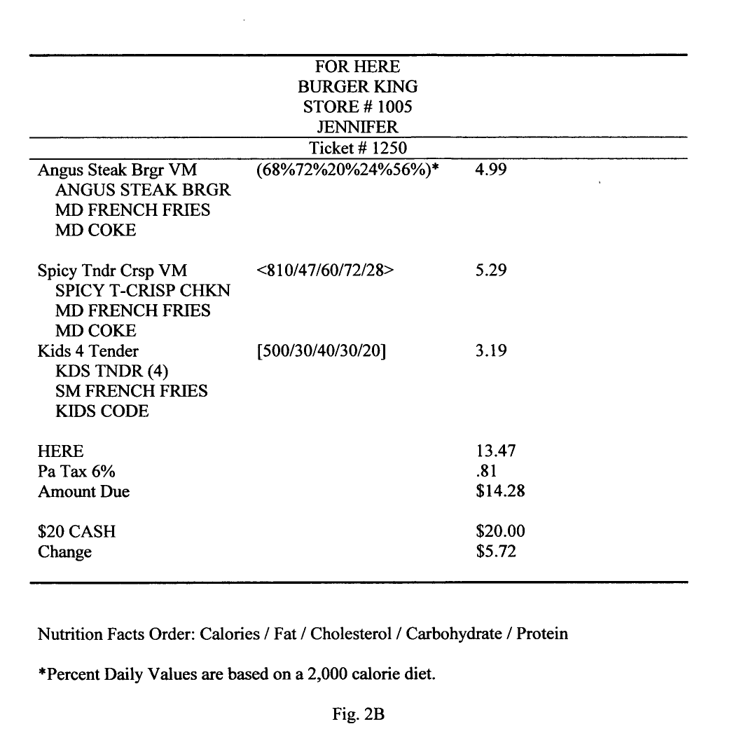

FIG. 2A shows a regular restaurant/food store/grocery store order ticket or receipt. In this order ticket, there are three individual orders or meals: an Angus Steak Burger, a Spicy Tender Crispy Chicken, and a Kids Meal. The individual order or meal of the Angus Steak Burger includes three sub-items: the Angus Steak Burger, French Fries, and a medium sized Coke. The individual order or meal of the Spicy Tender Crispy Chicken includes three sub-items: the Spicy Tender Crispy Chicken, French Fries, and a medium sized Coke. The Kids Meal includes four pieces of Chicken Tenders, small French Fires, and a Kids Soda. The individual order or meal of the Angus Steak Burger costs $4.99. The individual order or meal of the Spicy Tender Crispy Chicken costs $5.29. The Kids Meal costs $3.19.

FIG. 2B shows the restaurant/food store order ticket or receipt in accordance with the present invention. In this order ticket, there are three individual orders/meals, an Angus Steak Burger, a Spicy Tender Crispy Chicken, and a Kids Meal. The individual order or meal of the Angus Steak Burger includes three sub-items: the Angus Steak Burger, French Fries, and a medium sized Coke. The individual order or meal of the Spicy Tender Crispy Chicken includes three sub-items: the Spicy Tender Crispy Chicken, French Fries, and a medium sized Coke. The Kids Meal includes four pieces of Chicken Tenders, small French Fires, and a Kids Soda. The individual order or meal of the Angus Steak Burger costs $4.99. The individual order or meal of the Spicy Tender Crispy Chicken costs $5.29. The Kids Meal costs $3.19. According to the present invention, the nutrition information/nutrition facts for each individual order or meal will be shown on the receipt. In this example, the nutrition information or nutrition facts are displayed in the order of Nutrition Facts Order: Calories/Fat/Cholesterol/Carbohydrate/Protein. In this example, it shows three different formats for displaying the nutrition information/facts. For the individual order or meal of Angus Steak Burger, the nutrition information/facts are displayed in (68%72%20%24%56%). It means that the individual order or meal of the Angus Steak Burger contains 68% daily value of Calories, 72% daily value of Fat, 20% daily value of Cholesterol, and 56% daily value Protein. For the individual order or meal of the Spicy Tender Crispy Chicken, the nutrition information/facts are displayed in <810/47/60/72/28>. It means that the order of Tender Crispy Chicken contains 810 Calories, 47 g Fat, 60 mg Cholesterol, 72 g Carbohydrate, and 28 g Protein. For the Kids meal, it shows [500/30/40/30/20]. It means that the kids meal contains 500 Calories, 30 g Fat, 40 mg Cholesterol, 30 g Carbohydrate, and 20 g Protein. This is just an example of the order ticket/receipt. They may be in a different format. The customer can keep the order ticket or the receipt for tracking the nutrition/energy they took. He or she may enter their nutrition data into their nutrition control device later. It will help the user to keep track of the nutrition/energy they taken.

According to the present invention, the nutrition information/facts for each sub-item is stored in the above-mentioned cashier machine 100. Therefore, the nutrition information/facts can be displayed for each different order choice. For example, one customer orders a Hamburger with a large-size French Fries and a large Coke. The cashier machine 100 will look up the nutrition information in the storage/memory 102b, and sum up the total nutrition facts for each order, and will print the nutrition facts information in a certain format on the receipt or order ticket. The customer will enter the nutrition facts to their own weight watching or diet control device later based on the data shown on the ticket.

According to the present invention, in order to save the user's data entry time, the nutrition facts can be displayed by a shorter alternate codes, such as so called Points methods, or the other encoded math mapping method.

Therefore, the users/the customers will enter less data into their own weight watch or diet control system.

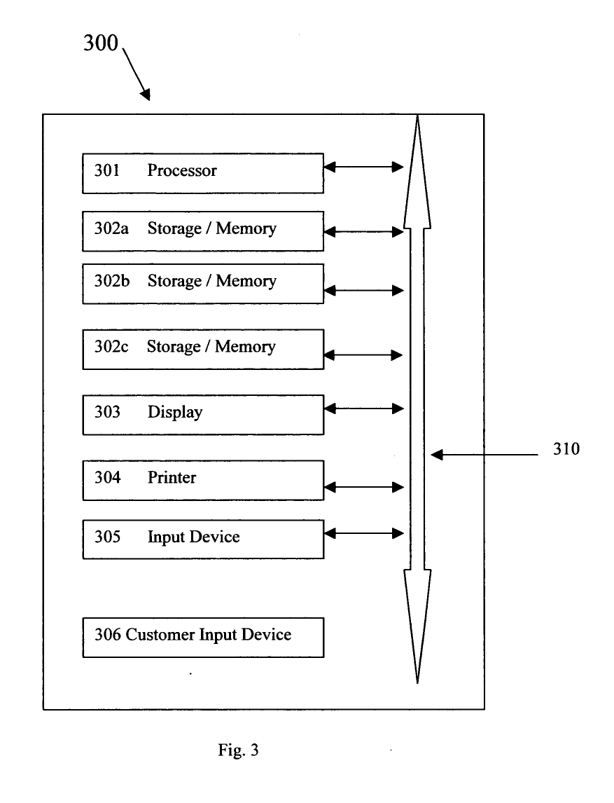

FIG. 3 shows another example of the nutrition/diet control system in accordance with the present invention. In this example, 300 is an order taking or a cashier machine in restaurant/food store/grocery store, which includes 301 processor, 302 storage/memory, 303 display device, 304 printing device, 305 key board or the other type input device for the cashier or the clerk entering the data into the order taking system or cashier machine 300, 306 customer input device, and 310 data bus. Storage/Memory 302a is used for storing the information about the food and its price, which is common to the regular casher machine. Storage/Memory 302b is for storing the nutrition information, such as nutrition facts data, for the food or meal, and Storage/Memory 302c is for storing the ingredient information and the other information, such as the taste (example: sweet or spicy), for the food or meal. The customer makes an order. For example, he orders a Hamburger, Coke, and Fries. After the cashier inputs the customer's order into the cashier machine 300 through the input device 305, the processor 301 will look up the price for each items in the order from the storage/memory 302a, and sum up the total price for this order. The processor 301 will also look up the nutrition facts data for each items or sub-items in the order from the storage/memory 302b, and sum up the total nutrition facts for this order. The processor 301 will also look up the ingredient information for each items from storage/memory 302c, and check whether or not there are ingredients the customer doesn't want. The system will print the customer's order ticket or the order receipt in a small slip/piece of paper, which shows the customer order with the food item name, the price, and the nutrition information/summary. The system may also display the nutrition data for the customer order on the display device 303 during the processing of the order. The customers input device 306, here, allows the customers to input their nutrition information, or ingredient information, or even taste choice into the cashier or the order-taking machine 300. Upon the customer's input, the processor 301 will look up the nutrition information or the ingredient information or even the other information such as taste in the storage/memory 302b or 302c, and display the best matches on the display device 303 to help the customer to select their meal. The customer input device 306 can be a simple keyboard/mouse, or a touch screen. The customer input device 306 can also be a barcode reader. In this case, the customer has a small nutrition card with the preprinted barcode for his individual nutrition requirement/preferred choice. He or she simply scans the card and sends his or her nutrition requirements or preferred choice to the cashier or the order-taking machine. The customer input device here can also be a small device with the advanced technology which can read, through the air (wireless) or RFID technology, the information from the customer's portable device, such as customer's cell phone/PDA or blackberry handhold device. In this case, the customer can send his required or preferred nutrition information or ingredient information to the customer input device 306 in the cashier/order-taking machine 300. For example, his preferred nutrition requirement for the lunch is 500 Calories. The processor 301 will look up the storage/memory 302b, and find the matches and show them on the display them for example, Crispy Chicken, on display 303 in the device 300.

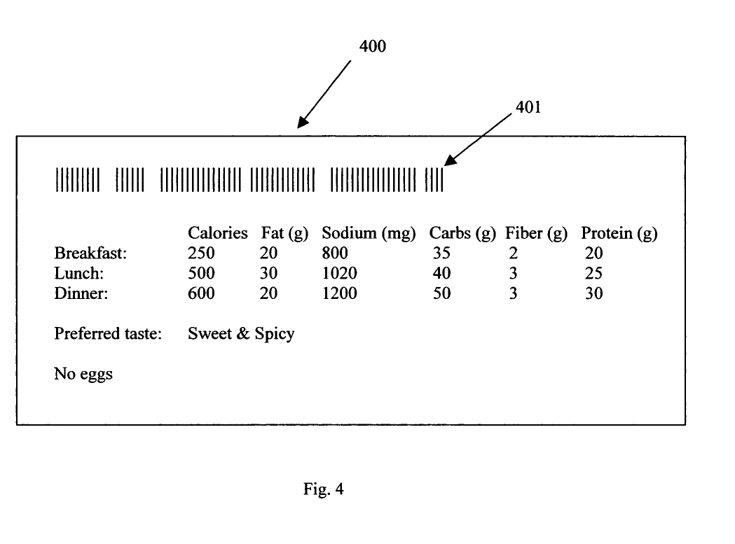

FIG. 4 shows an example of the nutrition card according to the present invention. In the nutrition card 400, there is a barcode 401 for the user's nutrition/ingredient requirements. In this example, the user's nutrition requirements are:

| | | | Sodium | Carbs | Fiber | |
|---|---|---|---|---|---|---|
| | Calories | Fat (g) | (mg) | (g) | (g) | Protein (g) |
| Breakfast: | 250 | 20 | 800 | 35 | 2 | 20 |
| Lunch: | 500 | 30 | 1020 | 40 | 3 | 25 |
| Dinner: | 600 | 20 | 1200 | 50 | 3 | 30 |

| | |
|---|---|
| Preferred taste: | Sweet & Spicy |
| No eggs | |

When using this card, the cardholder will either give the card to the person who is taking the order or scan the card into the cash machine or order-taking machine in FIG. 3. The employees will know the customer's requirements, and they can prepare the food based on them. The nutrition card of the present invention can also be used in the hospitals to help the doctors to control the nutrition their patients taken.

Although the above-mentioned nutrition card is a small card with pre-printed barcode for recording the user's preferred nutrition requirements, it can be something like smart card, PDA, cell phone, RFID, or the other portable devices.

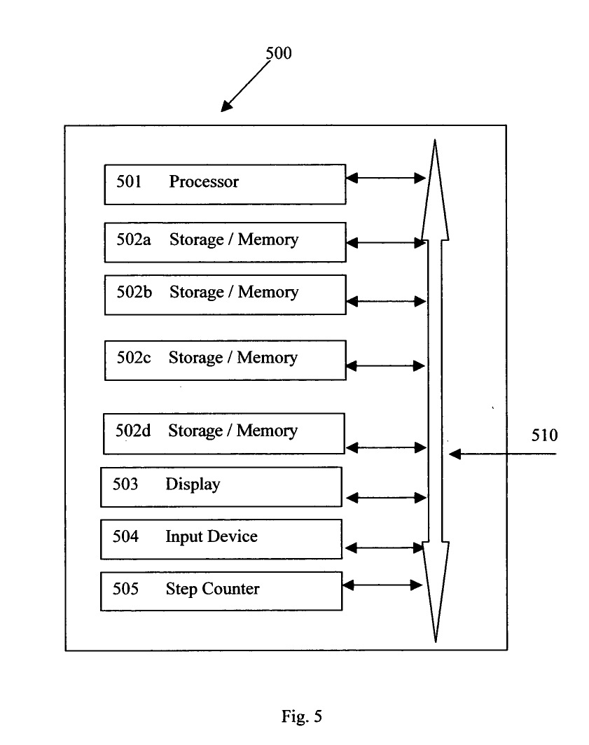

FIG. 5 shows another example of the nutrition/diet control system in accordance with the present invention. In this example, 500 is a customer portable device, such as a cell phone, PDA, RFID, or smart card/device, which includes 501 processor, 502 storage/memory, 503 display device, 504 keyboard/pad or other input device, 505 a step counter/pedometer, and 510 data bus. Storage/Memory 502a is a regular storage device for storing the information used by the users or the system in the device. Storage/Memory 502b is for storing the nutrition information, such as nutrition facts data, for many different kinds foods. Storage/Memory 502c is for storing the nutrition information such as fats, calories and protein the user has taken. Storage/Memory 502c may also store the table for the standard nutrition need per day, which are suggested by the doctors or the nutrition experts or the government. Storage/Memory 502d is for storing the nutrition/energy the user has consumed. Display device 503 is used for displaying the information to the user. The display device 503 is also used for displaying the nutrition information of the selected food to the user, and displaying the nutrition/energy the user consumed. Input device 504 is used for allowing the user to input the nutrition information, such as the nutrition information of the selected food, the nutrition/energy taken, or the nutrition/energy consumed. Step counter/Pedometer 505 is used for counting the steps the user taken, and sent the counts to Processor 501. Process 501 calculates the nutrition/energy consumed based a given algorithm, and add up it to Memory 502d. For example, if the user walked at the leisurely pace of 3 miles in hour, the system/device (or processor) will tell the storage 502d the user had consumed about 300 calories. If at a certain time, for example, by the end of the day, the system will check the nutrition/energy needed, the nutrition/energy consumed, and the nutrition/energy taken. If the nutrition/energy taken−the nutrition/energy consumed>the nutrition/energy needed, then the system will show a warning message from the display 503 or the like (such as the speaker). The user, after getting the warning message, will take some actions, such as another round walk. Then, the step counter will send more counts, which the user took, to the processor 501. Process 501 will, then, the new nutrition/energy consumed data to the storage 502d. The system will check they nutrition/energy needed, the nutrition consumed, and the nutrition taken, and comparing them. If the nutrition/energy taken—the nutrition/energy consumed<=the nutrition goal/need, the system will remove the warning message, or give good message like “Have a good night, you have taken a balanced diet today”, or even give special ring/tone telling the user whether or not he has taken a balanced diet today. If not, the system may also show message or give a special ring asking he or she to do more exercise to consume/burn the extra nutrition/energy.

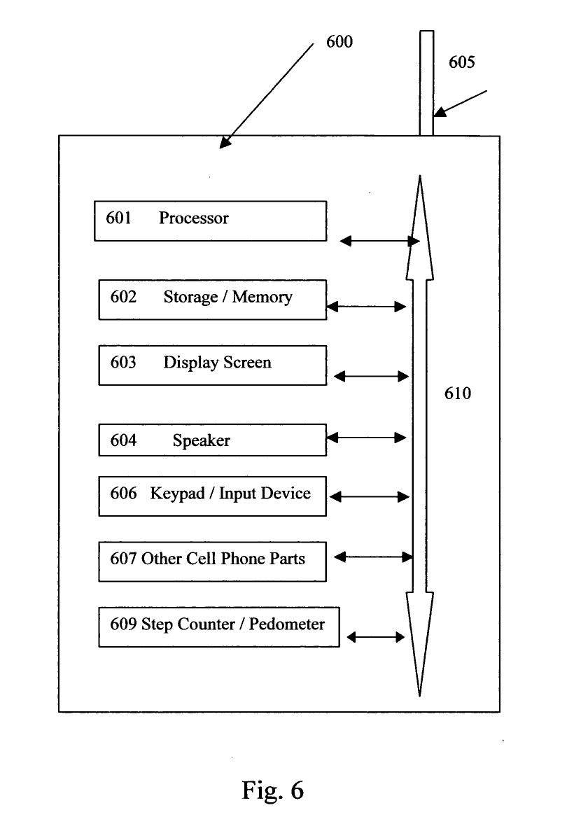

FIG. 6 shows another example of the nutrition/diet control system in accordance with the present invention. 600 is the cell phone (or the like such as blackberry or other mobile device) of the present invention, which includes a processor 601, a storage/memory 602, a display screen 603, a speaker 604, an antenna 605, a keypad/input device 606, and the other necessary cell phone parts/units 607, such as the keypad, receiver, battery, and etc. According to the present invention, the cell phone 600 further includes a step counter/pedometer 609, for walking and jogging. When a user walks or jogs while he or she is holding the cell phone 600, the step counter/pedometer 609 will count the steps the user took. Many people, at the most time, just put the cell phone in the cell phone case that is attached to the belt of the user. Therefore, the step counter/pedometer 609 will count the steps whenever he or she walks or jogs. The data bus 610 connects the above parts to each other. Storage/Memory 602 further includes the means for storing the nutrition information, the nutrition/energy taken, and the nutrition/energy consumed. The user can input the nutrition facts/energy taken into the storage 602 in the cell phone 600 through the keypad or the other methods. According to the present invention, the step counter/pedometer 609 counts how much the cell user walks. The processor 601 processes the data provided from the step counter/pedometer 609. According to the present invention, cell phone 600 is able to, through the antenna 605, send their nutrition/diet information, which include the nutrition/energy taken and the nutrition/energy consumed, to a host server, such as the host server for a hospital, a diet club, or an insurance company. In cell phone 600, the system or program will periodically send the user's nutrition/energy information to the hospital or the insurance company's or the fit club's server through the network connection, such as wireless connection. Therefore, the doctors in the hospital, the instructors in the diet club, or the persons in the insurance company will receive the nutrition information about their patients, club members, or their clients. For example, insurance company may lower the insurance fee for their clients based on how many steps they take per day. The processor 601 will check the nutrition/energy taken and the nutrition/energy consumed frequently. If the difference between the nutrition/energy taken and the nutrition/energy consumed is larger than the necessary nutrition/energy or the predefined certain level/the user's nutrition goal, it will show a warning message, on the display screen 603, to the user at certain time, such as when every time he or she starts to use the cell phone, or every evening before going bed. The message will remind the cell phone holder to exercise in order to burn off the extra calories. According the doctors/nutrition experts, based on some certain condition, such as weight or height, a person needs to take at least a certain amount (standard level) of exercise. In reality, most people will select walking for their exercise to burn the calories. According to the present invention, the step counter/pedometer will automatically record the steps, such the daily total steps, into the user's weigh watch/diet control system. The storage/memory 602 also stores the data/information (standard level) recommended by the doctors or the nutrition experts for comparing. The storage/memory 602 also stores the history about nutrition information, include energy taken, such as the nutrition facts taken, and the energy consumed, such as the steps taken, for a long term weight watch/nutrition control for the cell phone holder. The cell phone holder can simply use the keypad/input device to enter the nutrition/energy taken into to the cell phone, and store the nutrition/energy taken data into storage/memory 602. Therefore, the nutrition or diet control device according to present invention is capable, based on the comparing among the standard required nutrition/energy recommended by the doctors or the nutrition experts, the nutrition/energy taken, and the nutrition/energy consumed/burned, to give a better suggestion to the users, and show a warning message on the cell phone screen, or from cell phone speaker, or even give a special ring to the user to telling whether or not he has take a balanced diet today. According to the present of the invention, the storage/memory 602 further includes means for storing the allocation of the standard required nutrition/energy, the nutrition/energy taken, and the nutrition/energy consumed into a small time phase, for example, morning, afternoon, and night.

In this case, if the user just eats more in his lunch, the system will suggest him to do more exercise in the afternoon. Therefore, the nutrition/diet control device according to the present invention is able to give the user a better, more accurate/prompt suggestion on their taking nutrition/energy and consuming the nutrition/energy, and help the user to have a good strategy on his or her nutrition/diet control. According the present invention, the storage/memory 602 further include means for storing the information for activities and the calories burned through the activities. For example, washing your car by hand will burn 200 calories, playing TaiJi for 30 minutes will burn 250 calories, doing Yoga for 30 minutes will burn 200 calories. Based on how many extra calories need to be burned and the user preferred activities, the system/processor will lookup from activity storage means and give the user suggestions about what activity or activities the user should take. For example, at evening time, if the user still has 200 extra calories need to be burned, system/processor find out that 30 minutes TaiJi will burn 250 calories, and it will show a message or ring to the user and suggest that he or she should take 30 minutes TaiJi.

The best practice of weight control is to pay attention to what you eat and keep doing enough exercise. The cell phone with the nutrition/energy control function according to the present invention will definitely help the million users to control their weight.

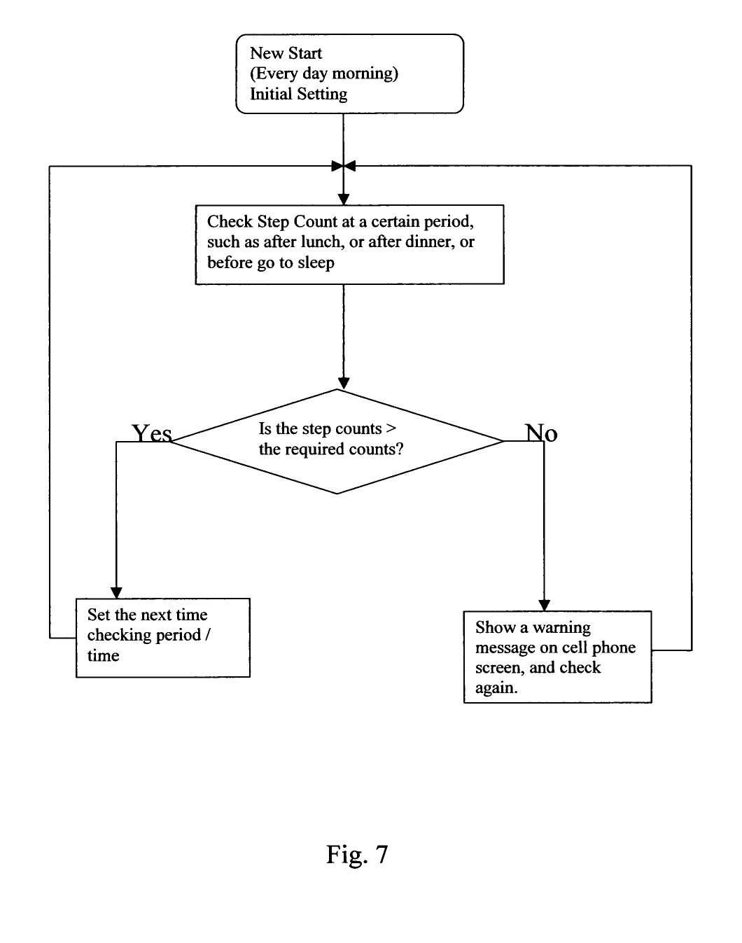

FIG. 7 is the flow chart showing how the device in FIG. 6 works.

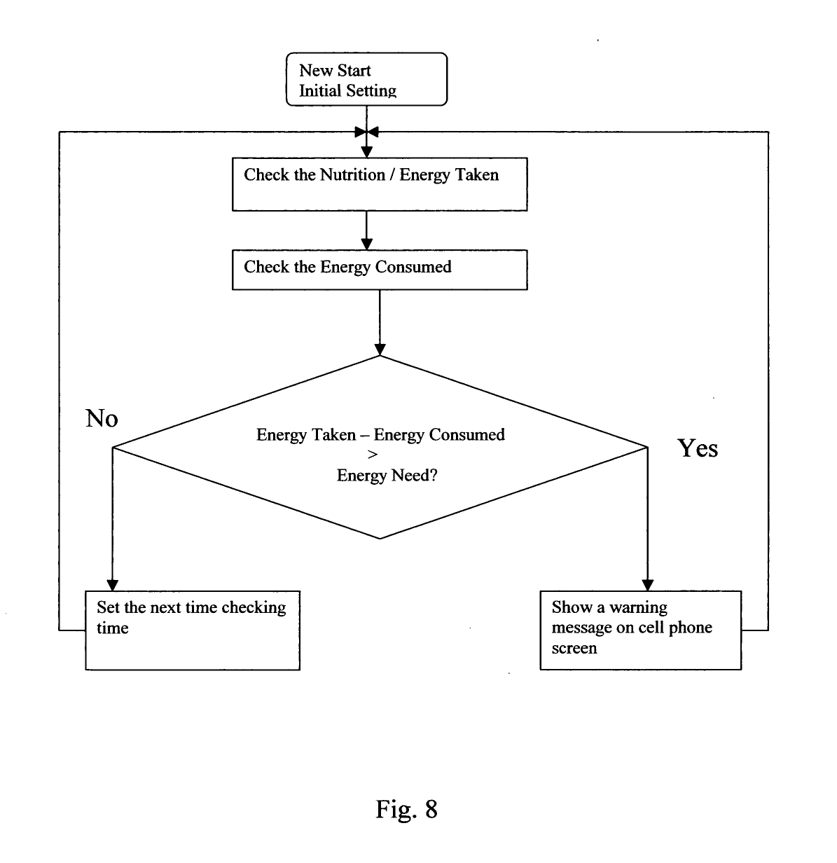

FIG. 8 is another flow chart showing

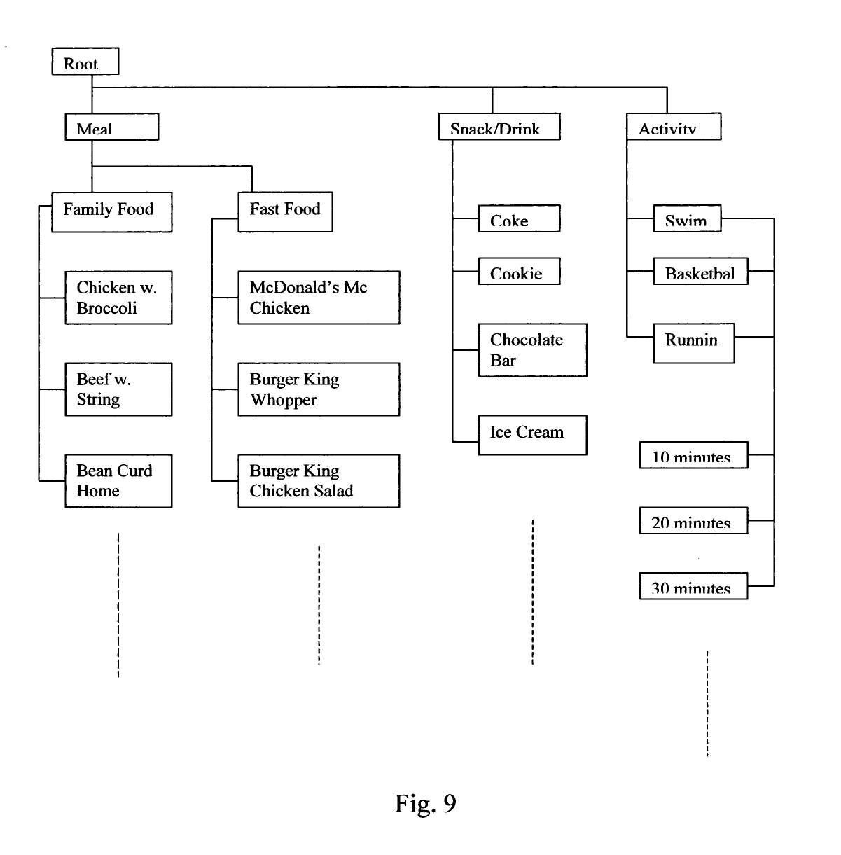

FIG. 9 depicts a hierarch tree structure. The tree shows how the different foods and the activities might be listed after having been organized by the hierarch tree. The user can easily select the foods he or she taken, and input it into the weight watch/diet control device. In the example shown, the first node in the root meal, the second node is snack/drink, and the third node is the activity. Thus, a user browsing would first select “Meal”, then select fast food, and then choose “Burger King Whopper”. The user can just use arrow up/down keys for entering the food he or she taken into the weight watch/diet control device. Same, the user can easily enter the how much energy he or she burned into the weight watch/diet or nutrition control. The weight watch/diet control device in accordance with the present invention also stores the nutrition/energy data for each food in its storage/memory so that it will convert the food taken into nutrition/energy information automatically, and use the nutrition/energy data to compare with the nutrition/energy needed, the nutrition/energy taken, and the nutrition/energy consumed, and then gives the user a better suggestion on his or her weight watch/diet or nutrition control. Before displaying the food/meal name in pull-down menu, system will, first, check the nutrition information and the user's nutrition goal/requirement, and then only shows the food/meal which meet the user's nutrition goal/requirement. For example, if user's nutrition goal for breakfast is 250 calories, the system will never show Big Mac on the menu for the breakfast for the user.

Although the invention has been described with reference to the above-described embodiments and examples, it will be appreciated that many other variations, modifications, and applications may be devised in accordance with the broad principles of the invention disclosed herein. The invention, including the described embodiments and examples and all related variations, modifications and applications is defined in the following claims.

Therefore, the forgoing is considered as illustrative only of the principles of the invention. Furthermore, since numerous modifications and changes will readily occur to those skilled in the art, it is not desired to limit the invention to the exact construction and operation shown and described. Accordingly, all suitable modifications and equivalents may be resorted to, falling within the scope of the invention.

1. An nutrition control system according to the present invention includes an order taking or order selecting or cashier machine, which includes:
means for processing data, such as calculations;
means for storing the data, such as meal/price table;
means for entering the order, such the food name, or the order number of the meal shown on the menu;
means for printing the order ticket or the receipt;
wherein the said nutrition control system further includes a storage means for storing the information regarding the nutrition or energy/food or meal; the said processing means can lookup the nutrition information by a given food or meal from the said storage means, and have the printing means to print the nutrition/energy information on the order ticket or the receipt for the food or meal ordered.

2. An nutrition control system according to claim 1, wherein the said order taking or the order selecting or cashier machine further includes displaying means for displaying the food or meal name and the food or meal nutrition/energy information for the order to the customers.

3. An nutrition control system according to claim 2, wherein the said order taking or order selecting or cashier machine further includes an input means allowing the customers to input their preferred nutrition/energy information, the said processing means check the nutrition/energy information for the food or meal ordered, and compared it with the said customer preferred nutrition/energy information, and give the customer a warning if the nutrition/energy for the food is out of the range of the said preferred nutrition/energy on the said displaying means.

4. An nutrition control system according to claim 3, wherein the said input means is a barcode reader or RFID reader or the like, which allow the customers input their preferred nutrition/energy information by just scanning their barcode card or their RFID chips.

5. A portable nutrition or diet control device according to the present invention includes:
means for processing data,
means for storing data,
means for displaying the information to the user,
means for inputting or entering data,
means for counting the step the user walked,
wherein, the said nutrition or diet control device further include the storing means for storing the information or data for the nutrition/energy the user needed, the nutrition/energy the user has taken, and the nutrition/energy the user has consumed, the user enter the nutrition/energy taken, or even the nutrition/energy consumed into the device through said inputting or entering means, the step counting means count the step the user has taken, and send the count to processing means, the processing means send the step counts into said nutrition information/data storing means.

6. A portable nutrition or diet control device according to claim 5, the processing means convert the step counts into nutrition/energy consumed data and store the nutrition/energy consumed data automatically into said nutrition information/data storing means, the processing means checks the nutrition/energy the user needed, the nutrition/energy the user has taken, and the nutrition/energy the user has consumed, and have the display means to display the said nutrition/energy information to the users, or have the displaying means to display a warning message if the nutrition/energy taken—the nutrition/energy consumed>the predefined necessary nutrition/energy.

7. A cell phone or the like with nutrition or diet control function according to the present invention includes:
means for receiving signals,
means for sending signals,
means for processing data,
means for storing data,
means for displaying the information to the user,
means for inputting or entering data, and the said cell phone further includes
means for counting the steps the user walked or jogged,
wherein when the user walks or jogs while holding the cell phone, the said step counter means count the steps the user took, and the processing means process the counts and store the counts information to the storing means.

8. A cell phone or the like with nutrition or diet control function, according to claim 7, further includes
means for storing the information or data for the nutrition/energy the user needed, the nutrition/energy the user has taken, and the nutrition/energy the user has consumed,
wherein the user enter the nutrition/energy taken, or even the nutrition/energy consumed into the nutrition information storing means through said inputting or entering means, the step counting means count the step the user has taken, and send the count to processing means, the processing means convert the step counts into nutrition/energy consumed data and store the nutrition/energy consumed data automatically into the nutrition information storing means, the processing means will, timely, such as daily, check the nutrition/energy the user needed, the nutrition/energy the user has taken, and the nutrition/energy the user has consumed, and have the displaying means to display a warning message if the nutrition/energy taken—the nutrition/energy consumed>the necessary nutrition/energy or the predefined nutrition/energy goal.

9. A cell phone or the like with nutrition or diet control function, according to claim 8, further includes
means for send their nutrition/diet information, which include the nutrition/energy taken and the nutrition/energy consumed, to a host server, such as the host server for a hospital, a diet club, or an insurance company.

10. A cell phone or the like with nutrition or diet control function, according to claim 7, further includes
storage means for storing the food names and their corresponding nutrition/energy information,
wherein when user select a particular food from the said displaying means, the said processing means will look for the nutrition/energy information, and shows the found nutrition/energy information on the displaying means to the user.
